(19) United States
(12) Patent Application Publication
(10) Pub. No.: US 2013/0289180 A1
(43) Pub. Date: Oct. 31, 2013

(54) Thermoplastic Resin Composition and Molded Article Including Same

(71) Applicant: Cheil Industries Inc., Gumi-si (KR)

(72) Inventors: Su Hak BAE, Uiwang-si (KR); Hae Kyung SONG, Uiwang-si (KR); Sung Hee AHN, Uiwang-si (KR); Hye Jin LEE, Uiwang-si (KR)

(21) Appl. No.: 13/924,900

(22) Filed: Jun. 24, 2013

Related U.S. Application Data
(63) Continuation-in-part of application No. PCT/KR2011/009040, filed on Nov. 24, 2011.

(30) Foreign Application Priority Data
Dec. 30, 2010 (KR) 10-2010-0139712
Nov. 22, 2011 (KR) 10-2011-0122562

(51) Int. Cl. C08K 5/523

(52) U.S. Cl. CPC C08K 5/523
USPC 524/141

(57) ABSTRACT

A thermoplastic resin composition includes (A) a rubber reinforced aromatic vinyl resin; (B) a recycled polyester resin; (C) a vinyl copolymer including an epoxy group; and (D) a phosphorus flame retardant. The thermoplastic resin composition can be flame retardant and environmentally friendly and can have improved falling ball impact strength, flowability (fluidity), chemical resistance, thermal stability and/or processability.

### CROSS-REFERENCE TO RELATED APPLICATIONS

This application is a continuation-in-part of International Application No. PCT/KR2011/009040, filed Nov. 24, 2011, pending, which designates the U.S., published as WO 2012/091300 and is incorporated herein by reference in its entirety, and claims priority therefrom under 35 USC Section 120. This application also claims priority under 35 USC Section 119 to and the benefit of Korean Patent Application No. 10-2010-0139712, filed Dec. 30, 2010, and Korean Patent Application No. 10-2011-0122562, filed Nov. 22, 2011, the entire disclosure of each of which is incorporated herein by reference

### FIELD OF THE INVENTION

The present invention relates to a thermoplastic resin composition and a molded article including the same.

### BACKGROUND OF THE INVENTION

Mixtures of an acrylonitrile-butadiene-styrene copolymer (ABS) resin and a polyethylene terephthalate (PET) resin can provide excellent processability and mechanical strength and are widely used in the production of interior or exterior components of electric and electronic products and office automation equipment. Recently, with growing interest in the environment, there have been attempts to use recycled PET which is eco-friendly and capable of reducing carbon emission.

However, an ABS/PET blend typically requires the addition of a styrene-acrylonitrile (SAN) copolymer containing an epoxy group. When SAN is added to the ABS/PET blend, however, flowability of the resin composition can be lowered during processing, which can deteriorate processability.

Further, an ABS/PET blend lacks combustion resistance and if a flame is generated by an external ignition factor, the resin may aid in combustion and spread of the fire. Consequently, in countries such as the US, Europe, and the like, it is stipulated that only resins having flame retardancy are to be used in the production of electric and electronic products in order to ensure stability against fire of electric and electronic products.

Generally, in order to impart flame retardancy, halogen compounds, for example, polybromodiphenyl ether, tetrabromobisphenol A, bromine-substituted epoxy compounds or chlorinated polyethylene and antimony compounds are used. These flame retardants have advantages in that flame retardancy is well ensured and reduction in physical properties does not substantially occur. However, these flame retardants can provide fatal influence on the human body due to hydrogen halide gases generated in the course of processing.

Moreover, when a molded article is fabricated of an ABS/PET blend, the article is essentially required to have impact strength, chemical resistance and thermal stability. Therefore, there is a need for an ABS/PET blend resin composition that ensures flame retardancy using a flame retardant capable of replacing existing halogen flame retardants, is eco-friendly, and has improved flowability, processability, impact strength, chemical resistance and thermal stability.

### SUMMARY OF THE INVENTION

The present invention provides a flame retardant thermoplastic resin composition which can be eco-friendly and can have improved flame retardancy, falling dart impact strength, flowability (fluidity), chemical resistance, thermal stability, and/or processability.

The present invention further provides a molded article produced using the thermoplastic resin composition.

In accordance with the present invention, a thermoplastic resin composition includes: (A) a rubber reinforced aromatic vinyl resin, (B) a recycled polyester resin, (C) a vinyl copolymer including an epoxy group, and (D) a phosphorus flame retardant, wherein the recycled polyester resin is recycled polyethylene terephthalate and present in an amount of about 5 parts by weight to about 35 parts by weight based on about 100 parts by weight of a base resin consisting of (A)+(B)+(C).

In one embodiment, the recycled polyethylene terephthalate may have an intrinsic viscosity of about 0.4 g/L to about 1.5 g/L measured in a 2-chlorophenol solution at 60° C. to 80° C.

In one embodiment, the thermoplastic resin composition may further include polyethylene terephthalate glycol (PETG).

In one embodiment, the phosphorus flame retardant may be represented by Formula 2:

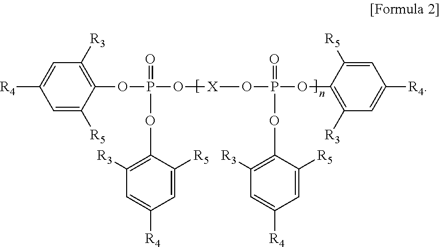

In one embodiment, the phosphorus flame retardant may be resorcinol bis(2,6-dimethylphenyl)phosphate.

In one embodiment, the thermoplastic resin composition may further include bisphenol-A bis(diphenylphosphate) (BDP).

A molded article of the present invention may be prepared from the thermoplastic resin composition.

The present invention provides a flame retardant thermoplastic resin composition which can be eco-friendly and can have improved properties in terms of flame retardancy, falling dart impact strength, flowability (fluidity), chemical resistance, thermal stability, and/or processability.

### DESCRIPTION OF DRAWINGS

FIG. 1 is a ¼ elliptical jig model for evaluating chemical resistance of a resin composition according to the present invention.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements. A specimen prepared from a thermoplastic resin composition of one embodiment of the invention may have a falling dart impact (FDI) strength of about 15 J to about 55 J, for example about 35 J to about 50 J. The falling dart impact strength can be measured by a typical method. For example, the falling dart impact strength can be measured by injection molding pellets prepared from the thermoplastic resin composition to obtain a rectangular specimen having a thickness of 3.2 mm and a width of 80 mm and calculating crack creation energy from the height at which a ball is dropped onto the specimen to create cracks, according to ASTM D3763.

The thermoplastic resin composition may have a melt index (MI) of about 25 g/10 minutes to about 40 g/10 minutes. The melt index can be measured by a typical method. For example, the melt index may be measured at 220° C. and under a load of 10 kg according to ASTM D1238.

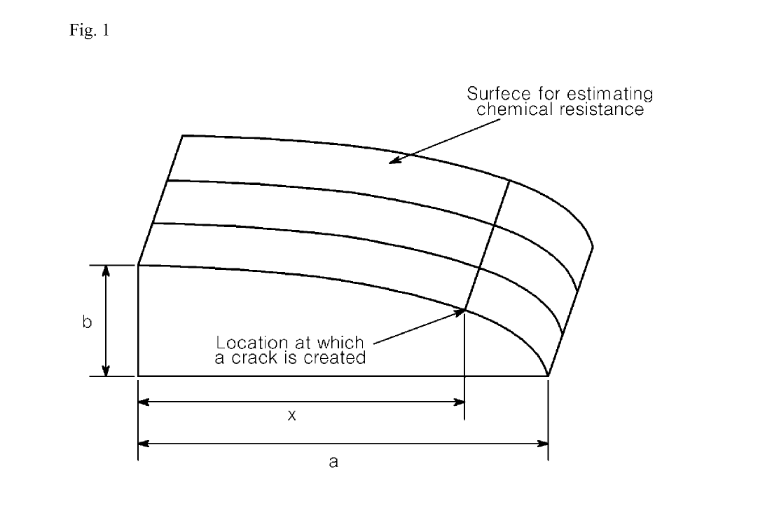

The thermoplastic resin composition may have a chemical resistance of about 1.0% to about 2.0%. The chemical resistance can be measured by a typical method. FIG. 1 illustrates one embodiment of a ¼ elliptical jig model for evaluating chemical resistance of a thermoplastic resin composition according to the present invention. A specimen of a model as shown in FIG. 1 is prepared through injection molding. The specimen is cut to a thickness of 15 mm, and then a chemical material is deposited thereon. The specimen is left at 25° C. for 72 hours and the location at which a crack is generated on the specimen is measured after removing the chemical material from the specimen. A critical strain (ε) is calculated according Equation 1. The critical strain is estimated according to the evaluation standard summarized in Table 2.

$$ɛ = \frac{{b}^{2}}{2 \times {a}^{2}} \times {\{ 1 - \frac{( {a}^{2} - {b}^{2} )}{{a}^{4}} \times {x}^{2} \}}^{- 3 / 2} \times t \times 100 , \qquad [ Equation 1 ]$$

wherein a is the length of the major axis of an elliptical jig model, b is the length of the minor axis of the elliptical jig model, t is the thickness of a specimen, and x is a distance from a vertical cross point between a location at which a crack is created in the elliptical jig model and the major axis of the elliptical jig model to a central point of the elliptical jig model.

The thermoplastic resin composition may have a yellowness index variation (ΔYI) of about 10 to about 20, for example about 10 to about 15, when a specimen prepared from the composition is held at 250° C. for 10 minutes. Accordingly, the specimen prepared from the composition of the invention may provide high thermal stability. Variation in yellowness index associated with thermal stability can be measured by a typical method. For example, the thermoplastic resin composition is placed in a cylinder at a molding temperature of 250° C. for 10 minutes and then subjected to injection molding to obtain specimens. The yellowness indices of the specimens obtained before or after being held at the molding temperature were measured according to ASTM D1925 and the difference in the yellowness indices is regarded as yellowness index variation.

The thermoplastic resin composition may have an Izod impact strength of about 11 kgf·cm/cm or more, as measured on a ¼″ thick specimen prepared from the composition according to ASTM D256.

The thermoplastic resin composition may have flame retardancy of V-2 or more, as measured on a specimen prepared from the composition according to UL 94 VB.

The thermoplastic resin composition of the invention can exhibit excellent properties in terms of falling dart impact strength, flowability, chemical resistance, thermal stability and/or flame retardancy.

The thermoplastic resin composition may include a rubber reinforced aromatic vinyl resin, a recycled polyester resin, a vinyl copolymer including an epoxy group, and a phosphorus flame retardant.

(A) Rubber Reinforced Aromatic Vinyl Resin

The rubber reinforced aromatic vinyl resin refers to a polymer in which a rubbery polymer is dispersed in the form of particles in a matrix including aromatic vinyl copolymer(s). The resin can be prepared by adding and polymerizing an aromatic vinyl monomer and a vinyl monomer in the presence of the rubbery polymer.

Examples of the rubber reinforced aromatic vinyl resin may include without limitation an acrylonitrile-butadiene-styrene copolymer (ABS) resin, an acrylonitrile-acrylic rubber-styrene copolymer (AAS) resin, an acrylonitrile-ethylene propylene rubber-styrene copolymer (AES) resin, and the like, and combinations thereof.

The rubber reinforced aromatic vinyl resin may be prepared by any known polymerization method such as emulsion polymerization, suspension polymerization, mass polymerization, and the like. The rubber reinforced aromatic vinyl resin may be prepared by mixing and extruding an aromatic vinyl graft copolymer resin alone or in combination with a aromatic vinyl copolymer resin. Extrusion may be performed at about 210° C., without being limited thereto. In mass polymerization, the rubber reinforced aromatic vinyl resin may be prepared by a single step reaction without separately preparing the aromatic vinyl graft copolymer resin and the aromatic vinyl copolymer resin. In the case of combining the aromatic vinyl graft resin and aromatic vinyl copolymer resin, the formulation may be performed taking into consideration compatibility.

In the rubber reinforced aromatic vinyl resin, the rubber may be present in an amount of 5 wt % to 30 wt %, based on the total weight of the rubber reinforced aromatic vinyl resin. In some embodiments, the rubber reinforced aromatic vinyl resin may include the rubber in an amount of about 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the rubber can be in a range from about any of the foregoing amounts to about any other of the foregoing amounts.

The rubber reinforced aromatic vinyl resin may include about 20 wt % to about 100 wt % of the aromatic vinyl graft copolymer resin and about 0 wt % to about 80 wt % of the aromatic vinyl copolymer resin. In exemplary embodiments, a mixture of about 40 to about 60 wt % of the aromatic vinyl graft copolymer resin and about 40 wt % to about 60 wt % of the aromatic vinyl copolymer resin can be extruded to prepare the rubber reinforced aromatic vinyl resin.

In some embodiments, the rubber reinforced aromatic vinyl resin may include the aromatic vinyl graft copolymer resin in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 wt %. Further, according to some embodiments of the present invention, the amount of the aromatic vinyl graft copolymer resin can be in a range from about any of the foregoing amounts to about any other of the foregoing amounts.

In some embodiments, the rubber reinforced aromatic vinyl resin may include the aromatic vinyl copolymer resin in an amount of 0 (the aromatic vinyl copolymer resin is not present), about 0 (the aromatic vinyl copolymer resin is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the aromatic vinyl copolymer resin can be in a range from about any of the foregoing amounts to about any other of the foregoing amounts.

The rubber modified aromatic vinyl resin may be prepared by extruding the mixture of the aromatic vinyl graft copolymer resin (A1) and aromatic vinyl copolymer resin (A2) in a weight ratio of about 1:0.5 to about 1:2 ((A1):(A2)).

(A1) Aromatic Vinyl Graft Copolymer Resin

The aromatic vinyl graft copolymer resin may be prepared by adding and polymerizing an aromatic vinyl monomer capable of being grafted to a rubbery polymer and a monomer copolymerizable with the aromatic vinyl monomer.

Examples of the rubbery polymer may include without limitation diene rubbers such as polybutadiene, poly(styrene-butadiene), and poly(acrylonitrile-butadiene) rubbers; saturated rubbers produced by adding hydrogen groups to the diene rubbers; isoprene rubbers; chloroprene rubbers; acrylic rubbers such as butyl acrylate rubbers; ethylene/propylene/diene monomer (EPDM) terpolymers; and the like, and combinations thereof. In exemplary embodiments, a polybutadiene rubber can be used.

The aromatic vinyl graft copolymer resin can include the rubbery polymer in an amount of about 5 wt % to about 65 wt % based on the total weight of the aromatic vinyl graft copolymer resin. In some embodiments, the aromatic vinyl graft copolymer resin can include the rubbery polymer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 64, or 65 wt %. Further, according to some embodiments of the present invention, the amount of the rubbery polymer can be in a range from about any of the foregoing amounts to about any other of the foregoing amounts.

The particles of the rubbery polymer may have an average particle size of about 0.1 μm to about 4 μm. The particle size can be selected based on impact strength and appearance of the aromatic vinyl graft copolymer.

Examples of the aromatic vinyl monomer capable of being grafted to a rubbery polymer may include without limitation styrene, a-methyl styrene, β-methyl styrene, p-methyl styrene, para-t-butyl styrene, ethyl styrene, vinyl xylene, monochlorostyrene, dichlorostyrene, dibromostyrene, vinylnaphthalene, and the like, and combinations thereof. In exemplary embodiments, styrene can be used.

The aromatic vinyl graft copolymer resin can include the aromatic vinyl monomer in an amount of about 30 wt % to about 94 wt % based on the total weight of the aromatic vinyl graft copolymer resin. In some embodiments, the aromatic vinyl graft copolymer resin can include the aromatic vinyl monomer in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, or 94 wt %. Further, according to some embodiments of the present invention, the amount of the aromatic vinyl monomer can be in a range from about any of the foregoing amounts to about any other of the foregoing amounts.

Examples of the monomer copolymerizable with the aromatic vinyl monomer may include without limitation saturated nitriles, unsaturated nitriles such as acrylonitrile and methacrylonitrile, and the like, and combinations thereof. In exemplary embodiments, acrylonitrile can be used.

The aromatic vinyl graft copolymer resin can include the copolymerizable monomer in an amount of about 1 wt % to about 20 wt %, for example about 10 wt % to about 20 wt %, based on the total weight of the aromatic vinyl graft copolymer resin. In some embodiments, the aromatic vinyl graft copolymer resin can include the copolymerizable monomer in an amount of about 1, 2, 3, 4, 5, 6, 7, 8, 9, 10, 11, 12, 13, 14, 15, 16, 17, 18, 19, or 20 wt %. Further, according to some embodiments of the present invention, the amount of the copolymerizable monomer can be in a range from about any of the foregoing amounts to about any other of the foregoing amounts.

When preparing the aromatic vinyl graft copolymer, monomers such as acrylic acid, methacrylic acid, maleic anhydride, N-substituted maleimide, and the like, and combinations thereof may be further added. The aromatic vinyl graft copolymer resin can include these monomers in an amount of about 0 wt % to about 15 wt % based on the total weight of the aromatic vinyl graft copolymer resin. In some embodiments, the aromatic vinyl graft copolymer resin can include these monomers in an amount of 0 (these monomers are not present), about 0 (one or more of these monomers is present), 1, 2, 3, 4, 5, 6, 7, 8, 9, 10, 11, 12, 13, 14, or 15 wt %. Further, according to some embodiments of the present invention, the amount of these monomers can be in a range from about any of the foregoing amounts to about any other of the foregoing amounts.

(A2) Aromatic Vinyl Copolymer Resin

The aromatic vinyl copolymer resin may be prepared by polymerizing the aromatic vinyl monomer mentioned in the preparation of the graft copolymer and a monomer copolymerizable with the aromatic vinyl monomer.

Examples of the vinyl monomer used in the aromatic vinyl copolymer resin may include without limitation styrene, α-methylstyrene, β-methylstyrene, p-methylstyrene, para-t-butylstyrene, ethyl styrene, vinyl xylene, monochlorostyrene, dichlorostyrene, dibromostyrene, vinyl naphthalene, and the like, and combinations thereof. In exemplary embodiments, styrene can be used.

The aromatic vinyl copolymer resin may include the aromatic vinyl monomer in an amount of about 60 wt % to about 90 wt %, for example about 70 wt % to about 80 wt %, based on the total weight of the aromatic vinyl copolymer resin. In some embodiments, the aromatic vinyl copolymer resin can include the aromatic vinyl monomer in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the aromatic vinyl monomer can be in a range from about any of the foregoing amounts to about any other of the foregoing amounts.

Examples of the monomer copolymerizable with the aromatic vinyl monomer may include without limitation saturated nitriles, unsaturated nitriles such as acrylonitrile, methacrylonitrile, and the like, and combinations thereof. In exemplary embodiments, acrylonitrile can be used.

The aromatic vinyl copolymer resin may include the copolymerizable monomer in an amount of about 10 wt % to about 40 wt %, for example about 20 wt % to about 30 wt %, based on the total weight of the aromatic vinyl copolymer resin. In some embodiments, the aromatic vinyl copolymer resin can include the copolymerizable monomer in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 wt %. Further, according to some embodiments of the present invention, the amount of the copolymerizable monomer can be in a range from about any of the foregoing amounts to about any other of the foregoing amounts.

The aromatic vinyl copolymer resin may further include a monomer such as acrylic acid, methacrylic acid, maleic anhydride, N-substituted maleimide, and the like, and combinations thereof to improve processability and heat resistance. The aromatic vinyl copolymer resin may include these monomers in an amount of about 0 wt % to about 15 wt % based on the total weight of the aromatic vinyl copolymer resin. In some embodiments, the aromatic vinyl copolymer resin can include these monomers in an amount of 0 (these monomers are not present), about 0 (one or more of these monomers is present), 1, 2, 3, 4, 5, 6, 7, 8, 9, 10, 11, 12, 13, 14, or 15 wt %. Further, according to some embodiments of the present invention, the amount of these monomers can be in a range from about any of the foregoing amounts to about any other of the foregoing amounts.

The rubber reinforced aromatic vinyl resin may be present in an amount of about 40 parts by weight to about 90 parts by weight, for example about 50 parts by weight to 85 parts by weight, based on about 100 parts by weight of a base resin including the (A) rubber reinforced aromatic vinyl resin, the (B) recycled polyester resin and the (C) vinyl copolymer including an epoxy group. In some embodiments, the base resin may include the rubber reinforced aromatic vinyl resin in an amount of about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 parts by weight. Further, according to some embodiments of the present invention, the amount of the rubber reinforced aromatic vinyl resin can be in a range from about any of the foregoing amounts to about any other of the foregoing amounts.

When the base resin includes the rubber reinforced aromatic vinyl resin in an amount within this range, the composition can provide excellent falling dart impact strength and chemical resistance.

(B) Recycled Polyester Resin

The use of the recycled polyester resin is economically advantageous and eco-friendly.

Examples of the recycled polyester resin may include without limitation polyethylene terephthalate (PET), polypropylene terephthalate, polybutylene terephthalate, polyethylene naphthalate, polybutylene naphthalate, and the like, and alloys thereof. In exemplary embodiments, recycled PET can be used.

The recycled PET may be prepared by removing foreign materials from a PET source. Examples of the PET source may include typical waste plastic containers, polyester extrudates, injection molded articles, and water bottles or containers for soft drinks, without being limited thereto. The foreign materials may be removed by washing the PET source with caustic aqueous sodium hydroxide and the like. Additionally, the PET source can be crushed and then subjected to re-extrusion to prepare recycled PET. The content of the foreign materials in the PET source or recycled PET can be determined by placing the prepared pellets or crushed PET between polyamide films, pressing the resulting mass in a press at 250° C. to prepare a disk film having a thickness of about 0.5 mm, and counting the number of foreign materials in the disk film.

The recycled PET may further include polyethylene terephthalate glycol (PETG). The PETG may be present in an amount of about 50 parts by weight to about 100 parts by weight, for example about 50 parts by weight to about 70 parts by weight, based on about 100 parts by weight of the recycled PET. In some embodiments, the recycled PET may include PETG in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 parts by weight. Further, according to some embodiments of the present invention, the amount of PETG can be in a range from about any of the foregoing amounts to about any other of the foregoing amounts. Within this range, flowability and impact strength of the resin composition can be improved.

The PETG may be present in an amount of 1 part by weight to 10 parts by weight, for example about 2 parts by weight to about 7 parts by weight, based on about 100 parts by weight of the base resin including the (A) rubber reinforced aromatic vinyl resin, the (B) recycled polyester resin and the (C) vinyl copolymer including an epoxy group. In some embodiments, the base resin may include PETG in an amount of about 1, 2, 3, 4, 5, 6, 7, 8, 9, or 10 parts by weight. Further, according to some embodiments of the present invention, the amount of the PETG can be in a range from about any of the foregoing amounts to about any other of the foregoing amounts.

The recycled polyester resin may have an intrinsic viscosity of about 0.4 g/L to about 1.5 g/L, for example about 0.7 g/L to about 1.0 g/L, as measured in a 2-chlorophenol solution at 60° C. to 80° C. Within this range, the flowability and processability of the resin composition can be improved.

The recycled polyester resin may be present in an amount of about 5 parts by weight to about 35 parts by weight, for example about 10 parts by weight to about 35 parts by weight, and as another example about 10 parts by weight to about 15 parts by weight, based on about 100 parts by weight of the base resin including the (A) rubber reinforced aromatic vinyl resin, the (B) recycled polyester resin and the (C) vinyl copolymer including an epoxy group. In some embodiments, the base resin may include the recycled polyester resin in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35 parts by weight. Further, according to some embodiments of the present invention, the amount of the recycled polyester resin can be in a range from about any of the foregoing amounts to about any other of the foregoing amounts.

If the amount of the recycled polyester is less than about 5 parts by weight, the resin composition can have undesirable chemical resistance and falling dart impact strength. If the amount of the recycled polyester exceeds about 35 parts by weight, the resin composition can have undesirable flowability since the recycled polyester resin becomes a crystalline resin.

(C) Vinyl Copolymer Including an Epoxy Group

The vinyl copolymer including an epoxy group is a resin prepared by copolymerizing a monomer mixture of an unsaturated epoxy monomer and a vinyl monomer, wherein the unsaturated epoxy group is contained in the vinyl copolymer. The monomer mixture can include about 0.001 mol % to about 5 mol % of the unsaturated epoxy monomer and about 99.999 mol % to about 95 mol % of the vinyl monomer.

Unsaturated Epoxy Monomer

The unsaturated epoxy monomer may be represented by Formula 1:

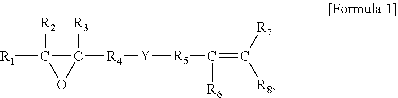

wherein R₁, R₂, R₃, R₆, R₇ and R₈ are the same or different and are each independently hydrogen, saturated or unsaturated C1-C12 alkyl, C6-C14 aryl, C6-C1-4 aryl substituted with saturated or unsaturated C1-C12 alkyl;

Y is an ether group (—O—), a carboxyl group (—O(C═O)—, —(C═O)O—), C1-C12 alkylene, C6-C14 arylene or C6-C14 arylene substituted with saturated or unsaturated C1-C12 alkyl;

R₄ and R₅ are the same or different and are each independently C1-C12 alkylene, C6-C14 arylene, or C6-C14 arylene substituted with saturated or unsaturated C1-C12 alkyl, with the proviso that when Y is an ether group (—O—) or a carboxyl group (—O(C═O)—, —(C═O)O—), then R₄ and R₅ are the same or different and are each independently C1-C12 alkylene, C6-C14 arylene, or C6-C14 arylene substituted with saturated or unsaturated C1-C12 alkyl; and further with the proviso that when Y is C1-C12 alkylene, C6-C14 arylene or C6-C14 arylene substituted with saturated or unsaturated C1-C12 alkyl, then Y represents a (R4-Y-R5) structure.

Examples of the unsaturated epoxy monomer may include without limitation glycidyl methacrylate, glycidyl acrylate, epoxy alkyl acrylate, allyl glycidyl ether, aryl glycidyl ether, butadiene monoxide, vinyl glycidyl ether, glycidyl itaconate, and the like. The unsaturated epoxy compound may be used alone or in combination of two or more thereof.

The vinyl copolymer including an epoxy group may include unsaturated epoxy monomer in an amount of about 0.001 mol % to about 5 mol %, for example about 1 mol % to about 3 mol %, based on the total mol % of the mixture of monomers constituting the vinyl copolymer including an epoxy group. Within this range, the composition can have improved impact strength effect and can prevent gelation upon extrusion.

Vinyl Monomer

The vinyl monomer may include an aromatic vinyl monomer and a monomer copolymerizable with the aromatic vinyl monomer.

Examples of the aromatic vinyl monomer may include without limitation styrene, a-methylstyrene, β-methylstyrene, p-methylstyrene, para-t-butylstyrene, ethyl styrene, vinyl xylene, monochlorostyrene, dichlorostyrene, dibromostyrene, vinylnaphthalene, and the like. The aromatic vinyl monomer may be used alone or as a mixture thereof.

Examples of the monomer copolymerizable with the aromatic vinyl monomer may include without limitation saturated nitriles, unsaturated nitriles such as acrylonitrile and methacrylonitrile, and the like, and combinations thereof. In exemplary embodiments, acrylonitrile can be used.

The vinyl copolymer including an epoxy group may include vinyl monomer in an amount of about 95 mol % to about 99.999 mol %, for example about 97 mol % to about 99 mol %, based on the total mol % of the mixture of monomers constituting the vinyl copolymer including an epoxy group. Within this range, the composition can exhibit excellent chemical resistance and flowability.

The vinyl copolymer including an epoxy group may be present in an amount of about 5 parts by weight to about 25 parts by weight, for example about 5 parts by weight to about 15 parts by weight, based on about 100 parts by weight of the base resin including the (A) rubber reinforced aromatic vinyl resin, the (B) recycled polyester resin and the (C) vinyl copolymer including an epoxy group. In some embodiments, the base resin may include the vinyl copolymer including an epoxy group in an amount of about 5, 6, 7, 8, 9, 10, 11, 12, 13, 14, 15, 16, 17, 18, 19, 20, 21, 22, 23, 24, or 25 parts by weight. Further, according to some embodiments of the present invention, the amount of the vinyl copolymer including an epoxy group can be in a range from about any of the foregoing amounts to about any other of the foregoing amounts.

When the base resin includes the vinyl copolymer including an epoxy group in an amount within this range, the resin composition can exhibit excellent compatibility without lowering flowability.

(D) Phosphorus Flame Retardant

The phosphorus flame retardant may be added to improve flame retardancy of the resin composition. The phosphorus flame retardant may be represented by Formula 2:

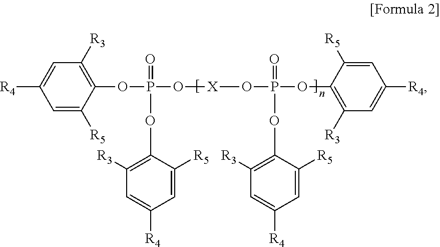

wherein R₃, R₄ and R₅ are the same or different and are each independently hydrogen or C1-C4 alkyl, X is C6-C20 aryl or C6-C20 aryl group substituted with C1-C4 alkyl, and n is an integer from 0 to 4.

X can be resorcinol or hydroquinone or dialcohol of bisphenol A, or may be derived from a resorcinol or hydroquinone or dialcohol of bisphenol A.

When n is 0, the phosphorus flame retardant may be triphenyl phosphate, tricresyl phosphate, trixylenyl phosphate, tri(2,6-dimethylphenyl)phosphate, tri(2,4,6-trimethylphenyl)phosphate, tri(2,4-di-tertiary-butylphenyl)phosphate, tri(2,6-di-tertiary-butylphenyl)phosphate, and the like. When n is 1, the phosphorus flame retardant may be resorcinol bis(diphenyl)phosphate, resorcinol bis(2,6-dimethylphenyl)phosphate, resorcinol bis(2,4-di-tertiary-butylphenyl)phosphate, hydroquinone bis(2,6-dimethylphenyl)phosphate, hydroquinone bis(2,4-di-tertiarybutylphenyl)phosphate, and the like. These phosphorus flame retardants may be used alone or as mixtures thereof.

In exemplary embodiments, the phosphorus flame retardant can include resorcinol bis(2,6-dimethylphenyl)phosphate. In exemplary embodiments, bisphenol-A (diphenylphosphate) (BDP) and resorcinol bis(2,6-dimethylphenyl)phosphate can be used together. Bisphenol-A (diphenylphosphate) may provide much better flame retardancy given the same content. Resorcinol bis(2,6-dimethylphenyl)phosphate and bisphenol-A (diphenylphosphate) (BDP) may be used in a weight ratio of about 1:0.5 to about 1:2.

The phosphorus flame retardant may be present in an amount of about 1 part by weight to about 15 parts by weight, for example about 1 part by weight to about 6 parts by weight, based on about 100 parts by weight of the base resin including the (A) rubber reinforced aromatic vinyl resin, the (B) recycled polyester resin and the (C) vinyl copolymer including an epoxy group. In some embodiments, the base resin may include the phosphorus flame retardant in an amount of about 1, 2, 3, 4, 5, 6, 7, 8, 9, 10, 11, 12, 13, 14, or 15 parts by weight. Further, according to some embodiments of the present invention, the amount of the phosphorus flame retardant can be in a range from about any of the foregoing amounts to about any other of the foregoing amounts.

When the base resin includes the phosphorous flame retardant in an amount within this range, the resin composition can exhibit excellent flame retardancy and flowability.

The resin composition may further include typical amounts of additives, such as flame retardants, lubricants, releasing agents, antistatic agents, dispersing agents, anti-dripping agents, impact modifiers, antioxidants, plasticizers, heat stabilizers, light stabilizers, weather-proofing stabilizers, compatibilizers, pigments, dyes, inorganic fillers, and the like, and mixtures thereof.

The resin composition may be prepared by a typical method. For example, the resin composition may be prepared by mixing such components, optionally, together with additives and melt-extruding the mixture in an extruder to prepare the resin composition in the form of pellets.

A molded article of the present invention may be prepared from the thermoplastic resin composition. Methods for preparing such molded articles are known to those skilled in the art. The molded article may be employed in interior or exterior parts of electric and electronic products, without being limited thereto.

Next, the present invention will be better elucidated from the following examples and comparative examples. It should be understood that these examples are provided for illustration only and are not to be construed in any way as limiting the scope of the invention.

Descriptions of details apparent to those skilled in the art will be omitted.

### Preparative Example 1

### Preparation of Rubber Modified Styrene Resin

(A1) Aromatic Vinyl Graft Copolymer Resin

To a mixture of 50 parts by weight of solid butadiene rubber latex powder, 36 parts by weight of styrene, 14 parts by weight of acrylonitrile and 150 parts by weight of deionized water, 1.0 part by weight of potassium oleate, 0.4 parts by weight of cumene hydroperoxide, 0.2 parts by weight of n-octyl mercaptan, 0.4 parts by weight of glucose, 0.01 parts by weight of ferric sulfate hydrate, and 0.3 parts by weight of sodium pyrophosphate are added. The mixture is reacted at 75° C. for 5 hours to prepare a graft copolymer resin. To the obtained graft copolymer resin, sulfuric acid is added in an amount of 0.4 parts by weight in terms of solid content to the obtained resin, which is then coagulated to obtain the resin in powder form.

(A2) Aromatic Vinyl Copolymer Resin

To a mixture of 75 parts by weight of styrene, 25 parts by weight of acrylonitrile, and 120 parts by weight of deionized water, 0.2 parts by weight of azobisisobutyronitrile and 0.4 parts by weight of tri-calcium phosphate, and 0.2 parts by weight of mercaptan based-chain transfer agent are added, heated from room temperature to 80° C. for 90 minutes, and left at 80° C. for 180 minutes to prepare a styrene/acrylonitrile copolymer resin (SAN). The copolymer resin is washed with water, dehydrated and dried, thereby preparing a styrene/acrylonitrile copolymer resin (SAN) in powder form.

(A) Rubber Reinforced Aromatic Vinyl Resin

The (A1) resin and the (A2) resin are mixed in a weight ratio of 1:1 and extruded at 210° C., thereby preparing a rubber reinforced styrene resin.

### Preparative Example 2

### Preparation of Recycled Polyethylene Terephthalate (PET)

In the preparation of recycled polyethylene terephthalate (PET), the processing step is very important. Polyethylene terephthalate recycled from water bottles and containers for soft drinks requires removal of foreign materials through organic and inorganic material washing processes using caustic sodium hydroxide. To further remove foreign materials, the crushed PET may be subjected to re-extrusion to obtain a recycled PET. Determination as to how many foreign materials are present in the recycled PET may be performed by placing 10 g of the prepared pellets or crushed PET between polyimide films, pressing in a press at 250° C. to obtain a pancake having a thickness of about 0.5 mm, and counting the number of foreign materials formed on the pancake.

Polyethylene terephthalate (A1100, Anychem) is re-extruded at 250° C. to prepare recycled polyethylene terephthalate. The prepared recycled polyethylene terephthalate may have an intrinsic viscosity of 0.75 g/L as measured in a 2-chlorophenol solution at 70° C.

### Preparative Example 3

### Preparation of Vinyl Copolymer Including Epoxy Group (Epoxy-Containing SAN)

To 100 parts by weight of a monomer mixture of 1 mol % of glycidyl methacrylate, 80 mol % of styrene and 19 mol % of acrylonitrile, 120 parts by weight of deionized water, 0.2 parts by weight of azobisisobutyronitrile, 0.4 parts by weight of tricalcium phosphate, and 0.2 parts by weight of n-octyl mercaptan are added. The mixture is heated to 80° C. for 60 minutes and left at 80° C. for 180 minutes to prepare a styrene-acrylonitrile copolymer resin containing an epoxy group. The obtained copolymer resin is washed with water, dehydrated and dried, thereby preparing a styrene-acrylonitrile copolymer resin containing an epoxy group (epoxy containing SAN).

Components used in Examples and Comparative Examples were as follows:

(A) Rubber reinforced styrene resin: A resin prepared in Preparative Example 1 is used.

(B) Recycled polyester resin: A recycled PET prepared in Preparative Example 2 is used.

(C) Vinyl copolymer containing an epoxy group: An epoxy containing SAN resin prepared in Preparative Example 3 is used.

(D) Phosphorus flame retardant: Resorcinol bis(2,6-dimethylphenyl)phosphate (PX200, Japan Daihachi Chemical Industries Co., Ltd.) is used.

(E) Polyethylene terephthalate glycol (PETG) (SKYGREEN, SK Chemicals) is used.

(F) Bisphenol-A bis(diphenylphosphate) (BDP) (CR-7415, Japan Daihachi Chemical Industries Co., Ltd.) is used.

(G) Bromine flame retardant/antimony trioxide system (Antimony trioxide, Chinese Grademan Co., Ltd.) is used.

### Examples 1-5

The components are mixed in amounts as listed in Table 1 (unit: parts by weight). The components are uniformly mixed in a Henschel mixer for 1 minute. The obtained mixture is extruded at 240° C. in a twin-screw extruder at a feed rate of 60 kg/hr and a screw speed of 250 rpm to prepare pellets. The resultant pellets are dried at 80° C. for 2 hours, followed by injection molding under conditions of a molding temperature of 180° C. and a mold temperature of 40° C. in a 6 oz extruder to prepare specimens.

### Comparative Examples 1-3

Specimens are prepared in the same manner as in the inventive examples except that the content of each component (unit: parts by weight) is changed as shown in Table 1.

TABLE 1

| | | | | | | Comparative | | |
|---|---|---|---|---|---|---|---|---|
| | Example | | | | | Example | | |
| | 1 | 2 | 3 | 4 | 5 | 1 | 2 | 3 |
| (A) | 85 | 80 | 50 | 85 | 85 | 91 | 55 | 85 |
| (B) | 10 | 15 | 35 | 10 | 10 | 3 | 40 | 10 |
| (C) | 5 | 5 | 15 | 5 | 5 | 5 | 5 | 5 |
| (D) | 4 | 4 | 4 | 4 | 2 | 4 | 4 | — |
| (E) | — | — | — | 5 | — | — | — | — |
| (F) | — | — | — | — | 2 | — | — | — |
| (G) | — | — | — | — | — | — | — | 4 |

### Experimental Example

### Measurement of Physical Properties

Physical properties of the specimens prepared in the examples and the comparative examples are measured as follows and results are shown in Table 3.

<Evaluation of Physical Properties>

1. Falling dart impact strength (J): Falling dart impact strength is evaluated according to ASTM D3763. Balls having a weight of 4.0 kg and a hemispheric diameter of 12.5 mm are dropped onto a rectangular specimen (thickness 3.2 mm×width 80 mm) prepared as above from different heights and the height at which a crack is created is evaluated. The height at which a crack is created was converted to energy to calculate falling dart impact strength.

2. Melt index (MI): Melt index is evaluated according to ASTM D1238. Melt index is evaluated at 220° C. under a load of 10 kg.

3. Chemical resistance: Chemical resistance is measured using a ¼ elliptical jig model (major axis: 120 mm, minor axis: 34 mm). Specimens are injection molded using a 6″×6″× 1/12″ (2.25 t at actual measurement) film gate mold. The specimens are cut into widths of 15 mm, to which a solution of Nanox (Lion Corporation, Japan) in 50% water is applied to a thickness of 100 μm. The resultant is wrapped with a PE film and left at 25° C. for 72 hours. The position of cracks is measured after removal of Nanox (Lion Corporation, Japan). Critical strain (ε) is calculated according Equation 1 and evaluated according to the evaluation standard in Table 2.

$$ɛ = \frac{{b}^{2}}{2 \times {a}^{2}} \times {\{ 1 - \frac{( {a}^{2} - {b}^{2} )}{{a}^{4}} \times {x}^{2} \}}^{3 / 2} \times t \times 100 , \qquad 〈 Equation 1 〉$$

wherein a is the length of the major axis of an elliptical jig model, b is the length of the minor axis of the elliptical jig model, t is the thickness of a specimen, and x is a distance from a vertical cross point between a location at which a crack is created in the elliptical jig model and the major axis of the elliptical jig model to a central point of the elliptical jig model.

TABLE 2

| Critical strain | Physical meaning | Meaning in product design |
|---|---|---|
| 2.0% or more | No crack was created | Stably usable |
| | unless extremely large | |
| | strain is applied. | |
| 1.0~2.0% | Crack was created at | Usable |
| | high strain. | |
| 0.5~1.0% | Crack was created at | Usable if care is taken in view |
| | relatively high strain. | of product design and service |
| | | environment |
| 0.3~0.5% | Crack was created at | Not suitable for use |
| | low strain. | |
| 0.3% or less | Crack was created at | Unusable |
| | molding deformation | |
| | strain. | |

4. Heat stability: The resin composition is left in a cylinder of an injection molding machine at 250° C. for 10 minutes and then injection molded to obtain samples. The yellow indexes of samples before and after the samples are left in the cylinder are measured using a CONICA Minolta Model CM-3600d according to ASTM D1925 and then variation in yellow index (ΔYI) are evaluated.

5. Izod impact strength: Izod impact strength is evaluated at a thickness of ¼″ according to ASTM D256.

6. Flame retardancy: Flame retardancy is evaluated as pass or fail according to UL 94 VB flame retardant standards.

TABLE 3

| | | | | | | Comparative | | |
|---|---|---|---|---|---|---|---|---|
| | Example | | | | | Example | | |
| | 1 | 2 | 3 | 4 | 5 | 1 | 2 | 3 |
| Falling dart | 35 | 40 | 50 | 40 | 35 | 30 | 60 | 20 |
| impact | | | | | | | | |
| strength (J) | | | | | | | | |
| Flowability | 35 | 30 | 28 | 37 | 38 | 38 | 15 | 50 |
| MI | | | | | | | | |
| (g/10 minutes) | | | | | | | | |
| Chemical | 1.3 | 1.5 | 1.8 | 1.4 | 1.2 | 0.9 | 1.8 | 0.7 |
| resistance | | | | | | | | |
| ε (%) | | | | | | | | |
| Heat Stability | 15 | 13 | 13 | 14 | 14 | 14 | 13 | 30 |
| (ΔYI) | | | | | | | | |
| Izod impact | 12 | 12.5 | 12 | 13 | 12 | 12 | 8 | 7 |
| Strength | | | | | | | | |
| (kgf · cm/cm) | | | | | | | | |
| Flame | V-2 | V-2 | V-2 | V-2 | V-2 | V-2 | fail | fail |
| retardancy | | | | | | | | |

As shown in Table 3, among the thermoplastic resin compositions including an ABS resin, recycled PET, a SAN rein including an epoxy group and a phosphorus flame retardant, the thermoplastic resin compositions of the present invention including about 5 parts by weight to about 35 parts by weight of the recycled PET exhibit outstanding properties in terms of falling dart impact strength, flowability, chemical resistance, heat stability, flame retardancy, and the like (Examples 1-3). The thermoplastic resin composition of the present invention further including PETG exhibits much better impact strength and flowability (Example 4). In addition, the thermoplastic resin composition of the present invention further including BDP together with resorcinol bis(2,6-dimethylphenyl)phosphate exhibits better flame retardancy (Example 5). In contrast, the resin compositions including less than about 5 parts by weight or greater than about 35 parts by weight of recycled PET exhibit undesirable properties in terms of falling dart impact strength, flowability, chemical resistance, and heat stability (Comparative Examples 1-2). Furthermore, the resin composition including a bromine flame retardant/antimony trioxide system instead of the phosphorus flame retardant exhibits remarkably deteriorated impact strength and heat stability due to degradation of the PET resin by antimony trioxide (Comparative Example 3).

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A thermoplastic resin composition comprising: (A) a rubber reinforced aromatic vinyl resin; (B) a recycled polyester resin; (C) a vinyl copolymer including an epoxy group; and (D) a phosphorus flame retardant,
wherein the recycled polyester resin includes recycled polyethylene terephthalate and is present in an amount of about 5 parts by weight to about 35 parts by weight based on about 100 parts by weight of a base resin including (A)+(B)+(C), and
wherein a specimen prepared from the thermoplastic resin composition has a falling dart impact strength of about 15 J to about 55 J according to ASTM D3763, a melt index of about 25 g/10 minutes to about 40 g/10 minutes according to ASTM D1238, a chemical resistance of about 1.0% to about 2.0%, and a thermal stability (AYI) of about 10 to about 20 according to ASTM D1925.

2. The thermoplastic resin composition according to claim 1, wherein the recycled polyethylene terephthalate has an intrinsic viscosity of about 0.4 g/L to about 1.5 g/L in a 2-chlorophenol solution at a temperature of 60° C. to 80° C.

3. The thermoplastic resin composition according to claim 1, further comprising polyethylene terephthalate glycol (PETG).

4. The thermoplastic resin composition according to claim 1, wherein the phosphorus flame retardant is represented by Formula 2: 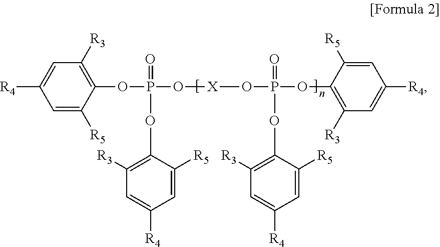
wherein R₃, R₄ and R₅ are the same or different and are each independently hydrogen or C1-C4 alkyl, X is C6-C20 aryl or C6-C20 aryl substituted with C1-C4 alkyl, and n is an integer from 0 to 4.

5. The thermoplastic resin composition according to claim 1, comprising the phosphorus flame retardant in an amount of about 1 part by weight to about 15 parts by weight based on about 100 parts by weight of the base resin including (A)+(B)+(C).

6. The thermoplastic resin composition according to claim 1, wherein the phosphorus flame retardant is resorcinol bis(2,6-dimethylphenyl)phosphate.

7. The thermoplastic resin composition according to claim 6, further comprising bisphenol-A bis(diphenylphosphate) (BDP).

8. The thermoplastic resin composition according to claim 1, wherein the rubber reinforced aromatic vinyl resin is prepared by formulating an aromatic vinyl graft copolymer resin alone or by formulating an aromatic vinyl graft copolymer resin and a, aromatic vinyl copolymer resin.

9. The thermoplastic resin composition according to claim 1, wherein the vinyl copolymer including an epoxy group is a copolymer of an unsaturated epoxy monomer and a vinyl monomer.

10. The thermoplastic resin composition according to claim 1, further comprising an additive selected from the group consisting of heat stabilizers, antioxidants, light stabilizers, compatibilizers, pigments, dyes, inorganic additives, and mixtures thereof.

11. A molded article prepared from the thermoplastic resin composition according to claim 1.
